(19) United States
(12) Patent Application Publication
(10) Pub. No.: US 2010/0271603 A1
(43) Pub. Date: Oct. 28, 2010

(54) STAGE FOR SUBSTRATE TEMPERATURE CONTROL APPARATUS

(76) Inventors: Kenichi Bandoh, Hiratsuka-shi (JP); Jun Sasaki, Hiratsuka-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/747,291

(22) PCT Filed: Dec. 15, 2008
(86) PCT No.: PCT/JP2008/072775

§ 371 Date: Jun. 10, 2010

(30) Foreign Application Priority Data
Jan. 18, 2008 (JP) 2008-008656

(51) Int. Cl. G03B 27/52

(52) U.S. Cl. 355/30

(57) ABSTRACT

A stage for substrate temperature control apparatus in which an extent of a transient temperature distribution that occurs when a substrate is heated or cooled can be reduced in comparison with the conventional one. The stage for substrate temperature control apparatus is a stage to be used for mounting a substrate having a predetermined diameter in a predetermined position in a substrate temperature control apparatus for controlling a temperature of the substrate, and includes: a plate formed with a step part, which is lower than a center part, on a first surface facing the substrate in a region including a position corresponding to an edge of the substrate; and a temperature control unit provided on a second surface opposite to the first surface of the plate.

### TECHNICAL FIELD

The present invention relates to a stage to be used for mounting a substrate such as a semiconductor wafer or a liquid crystal panel in a substrate temperature control apparatus for controlling a temperature of the substrate at treatment of the substrate.

### BACKGROUND ART

In recent years, it has been increasingly important to precisely control a temperature of a substrate such as a semiconductor wafer or a liquid crystal panel in the treatment process of the substrate. For example, in a manufacturing process of semiconductor devices, heating and cooling of the wafer are frequently performed in such a manner that, after a resist is applied to the wafer, the wafer is heated for removal of a resist solvent, and then, the wafer is cooled. For this, a substrate temperature control apparatus is used for appropriately controlling the temperature of the substrate.

The substrate temperature control apparatus includes a stage having a face plate for mounting the substrate thereon, and a heating device or a cooling device for heating or cooling the substrate is provided inside or in the lower part of the stage. Typically, an electric heating wire, an infrared lamp, or a working fluid is used as the heating device, and a Peltier device or a working fluid is used as the cooling device.

When a substrate is heated by using the substrate temperature control apparatus, due to influences of heat inflow from an outer circumferential part of the plate to the substrate, a time delay in which the substrate that bends convex upward when mounted on the plate becomes in parallel to the plate, and so on, a transient temperature distribution occurs in which the temperature is higher toward the outer circumference. Especially, in a concave plate having a concave surface for mounting a substrate, an extent of the temperature distribution is increased.

As a related technology, International Publication WO 01/13423 A1 discloses a semiconductor production device ceramic plate intended to heat a silicon wafer to a uniform temperature in its entirety. The ceramic plate is a ceramic plate for a semiconductor production device in which a semiconductor wafer is placed on a surface of the ceramic substrate or a semiconductor wafer is held at a specified distance away from the surface of the ceramic substrate, and characterized in that the surface, on or above which the semiconductor wafer is plate or held, of the ceramic substrate has a flatness of 1 μm to 50 μm in a measurement range of −10 mm in terms of outer periphery end-to-end length.

Japanese Patent Application Publication JP-P2002-198302A discloses a hotplate for a semiconductor manufacturing or inspection apparatus, which hotplate is effective for providing a uniform temperature distribution in a working surface of a ceramic substrate, i.e., a wafer heating surface, and further, advantageous in response at temperature rise and fall. The hotplate is a hotplate including a resistance heating element provided on the surface or inside of an insulating ceramic substrate, and has a shape in which the heat capacity of the outer circumference part of the ceramic substrate is smaller relative to the center part.

Japanese Patent Application Publication JP-A-8-124818 discloses a heat treatment apparatus intended to simplify a structure for a uniform heating temperature of a substrate to be treated and thereby improve a yield rate. The heat treatment apparatus includes a mounting stage on which a substrate to be treated is mounted, heating means for heating the substrate through the mounting stage, and supporting means projecting on the mounting stage so as to provide a predetermined gap between the substrate and the mounting stage, wherein the supporting means is formed of plural supports arranged at predetermined intervals on the mounting stage and the height of the plural supports is varied according to a heating temperature distribution of the substrate.

Japanese Patent Application Publication JP-P2002-83858A discloses a wafer heating apparatus using one principal surface of a uniform heating plate consisting of ceramics as a surface for mounting a wafer and having a heat generating resistor on the other principal surface thereof so as to heat the wafer. When the mounting surface becomes concave due to the warpage of the uniform heating plate, a gap between the uniform heating plate and the wafer becomes larger near the center of the wafer, and therefore, heating of the center part is slightly delayed at a temperature rise transient time when temperature setting of the uniform heating plate is changed or the wafer is replaced. As a result, an extent of the temperature distribution within the wafer surface is increased. Accordingly, the wafer heating apparatus is characterized in that the mounting surface is made convex.

However, even in the convex plate having the convex surface for mounting a substrate, the transient temperature distribution, in which the temperature is higher toward the outer circumference, also occurs in the substrate, and it is desired to reduce the extent of the temperature distribution.

### DISCLOSURE OF THE INVENTION

Accordingly, in view of the above-mentioned points, an object of the present invention is to provide a stage for substrate temperature control apparatus in which an extent of a transient temperature distribution that occurs when a substrate is heated or cooled can be reduced in comparison with the conventional one.

In order to achieve the above-mentioned object, a stage for substrate temperature control apparatus according to one aspect of the present invention is a stage to be used for mounting a substrate having a predetermined diameter in a predetermined position in a substrate temperature control apparatus for controlling a temperature of the substrate, and the stage includes: a plate formed with a step part, which is lower than a center part, on a first surface facing the substrate in a region including a position corresponding to an edge of the substrate; and a temperature control unit provided on a second surface opposite to the first surface of the plate.

According to the one aspect of the present invention, since the step part lower than the center part is formed on the first surface of the plate facing the substrate in the region including the position corresponding to the edge of the substrate, the transient temperature distribution that occurs when the substrate is heated or cooled can be reduced in comparison with the conventional one.

### BRIEF DESCRIPTION OF THE DRAWINGS

FIG. 1 is a plan view showing a stage for substrate temperature control apparatus according to one embodiment of the present invention;

FIG. 2 is a sectional view along alternate long and short dash line II-II as shown in FIG. 1;

FIG. 3 is a sectional view schematically showing a plate and a heater of the stage for substrate temperature control apparatus according to one embodiment of the present invention together with a wafer;

FIG. 4 shows experimental results when a wafer is heated by using plates having concave upper surfaces;

FIG. 5 shows experimental results when a wafer is heated by using various plates;

FIG. 6 shows experimental results when the depth of a groove is varied;

FIG. 7 shows a temperature distribution in the radial direction of a wafer at the time when an in-plane temperature range is the maximum in FIG. 6;

FIG. 8 shows an element model used for simulations;

FIG. 9 shows a first simulation result;

FIG. 10 shows a second simulation result; and

FIG. 11 shows modified examples of groove shapes of the plate in the one embodiment of the present invention.

### BEST MODE FOR CARRYING OUT THE INVENTION

Hereinafter, an embodiment of the present invention will be explained in detail by referring to the drawings. The same reference characters are assigned to the same component elements and the description thereof will be omitted.

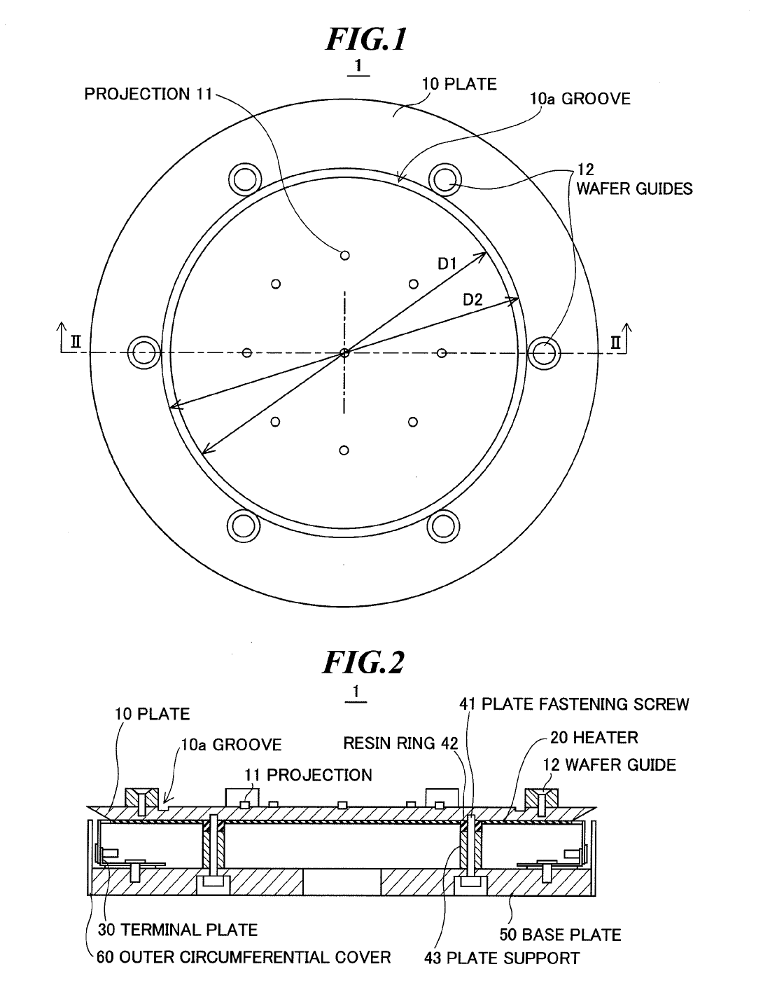

FIG. 1 is a plan view showing a stage for substrate temperature control apparatus according to one embodiment of the present invention, and FIG. 2 is a sectional view along alternate long and short dash line II-II as shown in FIG. 1. A substrate temperature control apparatus is an apparatus for controlling the temperature of a substrate such as a semiconductor wafer or a liquid crystal panel in a treatment process of the substrate, and has a stage 1 to be used for mounting the substrate. As below, the case where a semiconductor wafer having a diameter of 300 mm is mounted on the stage 1 will be explained.

As shown in FIGS. 1 and 2, the stage 1 of the substrate temperature control apparatus includes a plate (face plate) 10 having a disk shape, and plural projections 11 having heights of about 100 μm are provided on the upper surface of the plate 10. When a wafer is mounted on the stage 1, the projections 11 support the lower surface of the wafer and form a gap of about 100 μm between the wafer and the plate 10 so as to prevent the wafer from contacting the plate 10. Thereby, the wafer is protected from contaminants adhering to the plate 10. On the peripheral part of the plate 10, plural wafer guides 12 for regulating a position of an edge of the wafer mounted on the stage 1 are provided.

Referring to FIG. 2, a circular sheet-like (planar) heater 20 as a temperature control unit for heating the wafer is attached to the lower surface of the plate 10, and a terminal plate 30 is provided for wiring the heater 20. The plate 10 and the heater 20 are fastened to a base plate 50 via a resin ring 42 and a plate support 43 by using a plate fastening screw 41. Due to the resin ring 42, heat is insulated between the plate 10 and the base plate 50, and the plate 10 becomes movable to some degree relative to the base plate 50 by sliding on the resin ring 42. An outer circumferential cover 60 is attached around the base plate 50. The stage 1 is accommodated in a case of the substrate temperature control apparatus. As the temperature control unit, not only the planar heater but also thermoelectric devices may be arranged on one entire surface or channels for flowing fluids may be provided, and the plate 10 can be used for both heating and cooling.

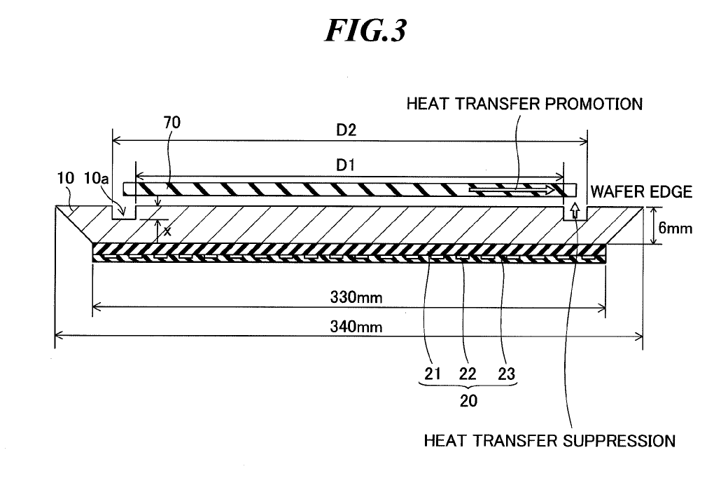

FIG. 3 is a sectional view schematically showing a plate and a heater of the stage for substrate temperature control apparatus according to one embodiment of the present invention together with a wafer.

The plate 10 is made of a thin aluminum material (A5052), and has a circular truncated cone shape with a thickness of 6 mm, a longer diameter of 340 mm, and a shorter diameter of 330 mm. In order to prevent thermal deformation, alumite treatment may be performed on the plate 10 to form an alumite layer in 15 μm to 30 μm except for the part to which the heater 20 is bonded.

The heater 20 includes an insulating film 21 of polyimide, an electric heating wire 22 of a thin film of a stainless steel material (SUS304) patterned on the insulating film 21, and an insulating film 23 of polyimide for covering the electric heating wire 22. Here, the thickness of the insulating film 21 is 50 μm, the thickness of the electric heating wire 22 is 20 μm, and the thickness of the insulating film 23 is 25 μm in the thin part . The surfaces of the polyimide of the insulating films 21 and 23 are reformed to be bonded (thermally fused) to other members when heated to 300° C. or higher, and the plate 10 and the insulating film 21 and the insulating film 23 are hot-pressed and bonded to one another.

Since aluminum is relatively soft and has a larger linear coefficient of expansion than those of stainless and polyimide, when the plate 10 is heated by the heater 20, deformation that the upper surface (substrate mounting surface) of the plate 10 becomes convex occurs. Accordingly, in the embodiment, the substrate mounting surface of the plate 10 is formed to tend to have a concave shape at a room temperature (flatness: about 0 μm to 60 μm).

Here, according to a first aspect of the present invention, when a substrate (wafer) having a predetermined diameter is mounted on the stage such that the center axis of the substrate is aligned with the center axis of the plate 10, a step part lower than the center part is formed on the substrate mounting surface of the plate 10 in a region including a position corresponding to the edge of the substrate. The step part typically has a shape of a groove 10a as shown in FIGS. 1 to 3.

It is desirable that the groove 10a extends to a distance of 4 mm to 30 mm measured from the position corresponding to the edge of the substrate toward the center of the plate 10 on the substrate mounting surface of the plate 10. Therefore, in the case where the diameter of the substrate is 300 mm, the diameter D1 of the inner circumference of the groove 10a is 240 mm to 292 mm.

It is desirable that the diameter D2 of the outer circumference of the groove 10a is made not larger by more than 1 mm than the edge of the substrate in order to reduce the area difference (heat transfer area difference) between areas where the groove 10a lies over the peripheral part of the substrate when the center axis of the substrate may be shifted by about 2 mm from the center axis of the plate 10. Therefore, in the case where the diameter of the substrate is 300 mm, the diameter D2 of the outer circumference of the groove 10a is 300 mm to 302 mm. On the other hand, when the shift of the substrate is smaller (less than about 0.5 mm), it is not necessary to set the upper limit of the diameter D2 of the outer circumference of the groove 10a, and it is not problematic even when the groove 10a extends to the edge of the plate 10. Therefore, the term “step part” is used in the present application to include this case.

Further, according to a second aspect of the invention, the groove 10a is formed on the substrate mounting surface of the plate 10 at the outer circumference side than the plural projections 11 and at the inner circumference side than the plural guide members (wafer guides) 12. Thereby, when the substrate is mounted on the stage such that the center axis of the substrate is aligned with the center axis of the plate 10, the groove 10a lies over the edge part of the substrate. Also, in this case, it is desirable that the diameter D1 of the inner circumference and the diameter D2 of the outer circumference of the groove 10a satisfy the above-mentioned conditions.

Furthermore, according to a third aspect of the invention, the groove 10a is formed on the substrate mounting surface of the plate 10 at the inner circumference side than the plural guide members (wafer guides) 12, and the plural projections 11 are arranged such that at least one projection lies over the region in which the groove 10a is formed. That is, at least one entire projection may exist in the region in which the groove 10a is formed, or a part of the projection may exist in the region in which the groove 10a is formed. Thereby, when the substrate is mounted on the stage such that the center axis of the substrate is aligned with the center axis of the plate 10, the groove 10a lies over the edge part of the substrate. Also, in this case, it is desirable that the diameter D1 of the inner circumference and the diameter D2 of the outer circumference of the groove 10a satisfy the above-mentioned conditions.

When a wafer 70 is heated by using a substrate temperature control apparatus, due to influences of heat inflow from the outer circumferential part of the plate 10 to the wafer 70, a time delay in which the wafer 70 that bends convex upward when mounted on the plate 10 becomes in parallel to the plate 10, and so on, a transient temperature distribution occurs in the wafer 70 in which the temperature is higher toward the outer circumference.

Accordingly, as shown in FIG. 3, the groove 10a is formed in the surface region of the plate 10 located below the edge part of the wafer 70, and thereby, heat transfer from the region of the plate 10 to the wafer 70 is suppressed to reduce the temperature rise velocity in the outer circumferential part of the wafer 70 while heat transfer from the center part to the outer circumferential part of the wafer 70 is promoted so as to uniformize the temperature.

Further, the temperature in the outer circumferential part of the wafer 70 is easier to be nonuniform compared to the center part due to heat insulation by air at the side surface. However, since the groove 10a is formed on the plate 10, the gap between the plate 10 and the wafer 70 becomes larger, and thereby, the nonuniformity of the temperature depending on the flatness of the plate 10 and the wafer 70 is relaxed.

Furthermore, by optimization of the depth (x), the sizes (D1, D2), and the shape of the groove 10a, a nearly flat transient temperature distribution can be realized. In the case where the plate 10 having a concave upper surface is used, there is a tendency that the spread of the temperature distribution in the wafer is larger than in the case where a plate having a flat or convex upper surface is used. The present invention is especially effective in this case.

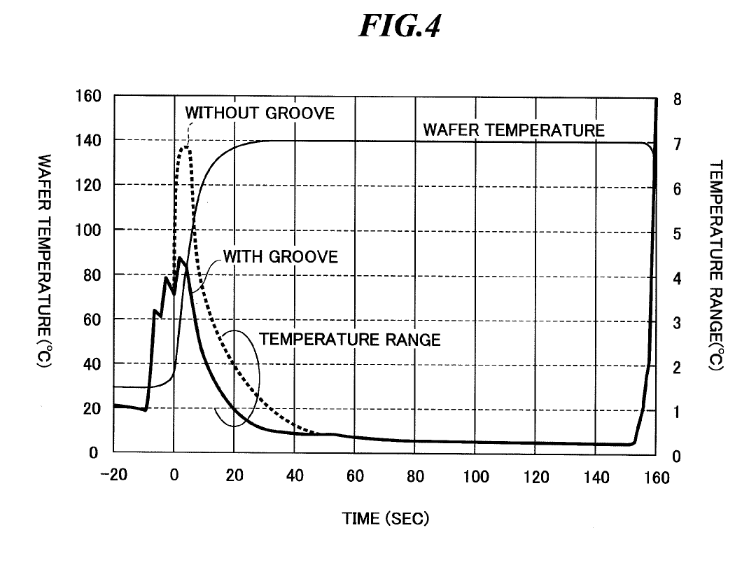

FIG. 4 shows experimental results when a wafer is heated by using plates having concave upper surfaces. In the plates used for the experiments, the flatness of the upper surface at a room temperature is 58 μm. For comparison, a plate without groove (comparative example) and a plate with groove (working example) are used. In the working example, the diameter of the inner circumference of the groove is 292 mm and the diameter of the outer circumference of the groove is 306 mm, and therefore, the width of the groove is (306-292)/2=7 mm. Further, the depth of the groove has a distribution from 54 μm to 189 μm on the circumference, and its average value is 130 μm.

In FIG. 4, an average of wafer temperatures measured at plural measurement points within a wafer surface when the wafer is heated and a temperature range as a difference between the maximum value and the minimum value in the wafer temperatures are shown. The smaller the temperature range, the more uniform the temperature distribution of the wafer. As shown in FIG. 4, when the wafer temperature rises from near the room temperature to 140° C., in the case where the plate without groove is used, the temperature range is expanded to about 6.8° C. at the maximum. On the other hand, in the case where the plate with groove is used, the temperature range is as small as about 4.4° C. at the maximum and the temperature distribution of the wafer is regarded as being uniform.

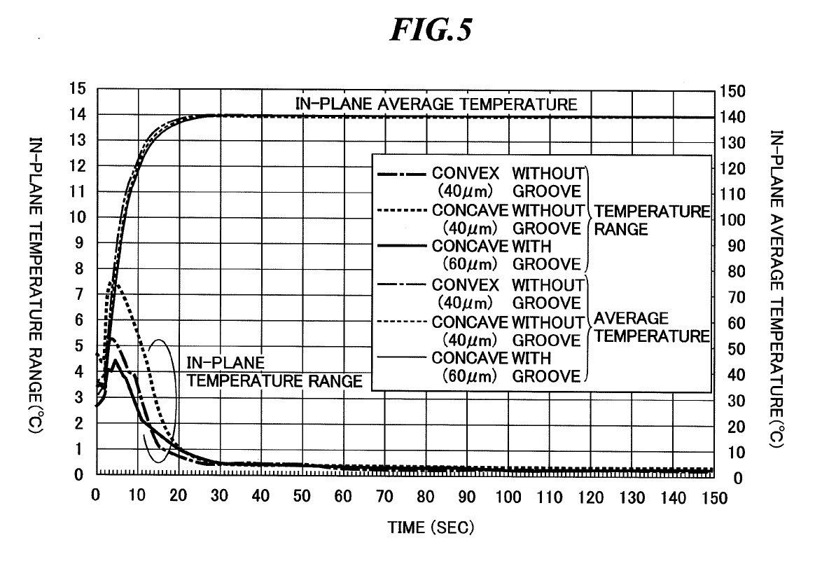

FIG. 5 shows experimental results when a wafer is heated by using various plates. Here, a plate having a convex upper surface (flatness: 40 μm) without groove (comparative example 1), a plate having a concave upper surface (flatness: 40 μm) without groove (comparative example 2), and a plate having a concave upper surface (flatness: 60 μm) with groove (working example) are compared. In the working example, the diameter of the inner circumference of the groove is 292 mm and the diameter of the outer circumference of the groove is 306 mm, and therefore, the width of the groove is 7 mm. Further, the average value of the groove depth is 130 μm.

In FIG. 5, an in-plane average temperature as an average of temperatures measured at plural measurement points within a wafer surface when the wafer is heated and an in-plane temperature range as a difference between the maximum value and the minimum value in the temperatures are shown. As shown in FIG. 5, the plate having a concave upper surface (comparative example 2) has an in-plane temperature range of about 7.5° C. at the maximum, while the plate having a convex upper surface (comparative example 1) has an in-plane temperature range of about 5.3° C. at the maximum and is advantageous in the temperature distribution of the wafer. On the other hand, according to the present invention, even in the plate having a concave upper surface, the in-plane temperature range can be made about 4.4° C. at the maximum. The differences between rising velocities of the in-plane average temperatures in FIG. 5 depend on the shapes (concave and convex) and the flatness of the plates.

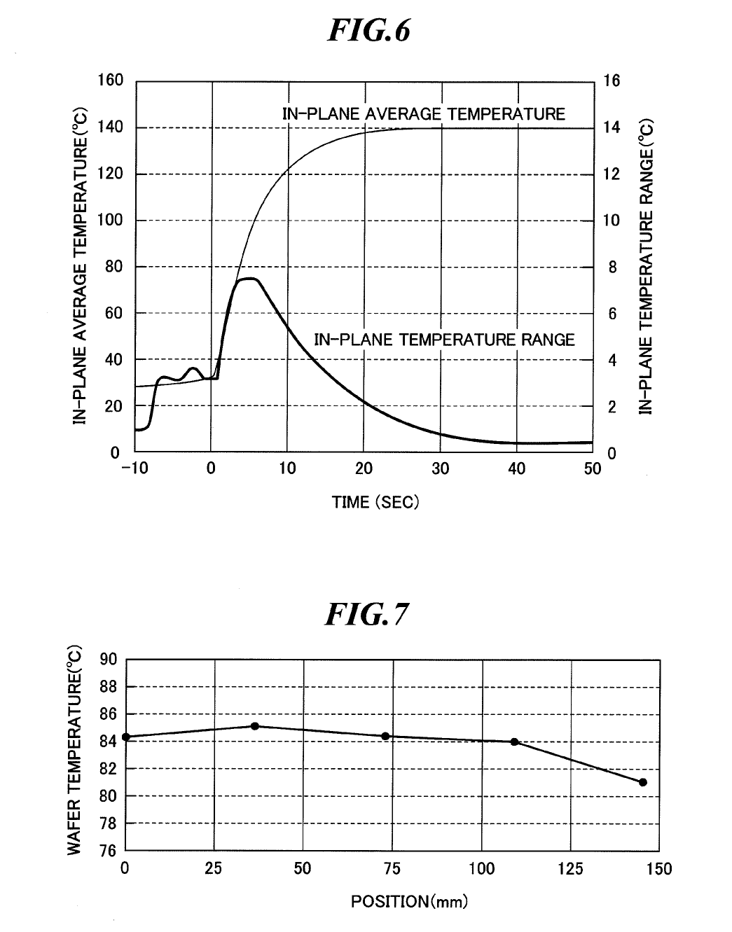

FIG. 6 shows experimental results when the depth of the groove is varied. Here, plates each having a concave upper surface (flatness: 40 μm) and a groove depth of 750 μm on average are used. The diameter of the inner circumference of the groove is 292 mm and the diameter of the outer circumference of the groove is 306 mm, and therefore, the width of the groove is 7 mm.

As shown in FIG. 6, the in-plane temperature range is about 7.5° C. at the maximum. FIG. 7 shows a temperature distribution in the radial direction of the wafer at the time when the in-plane temperature range is the maximum in FIG. 6. In FIG. 7, it is found that a reverse phenomenon occurs in which the temperature is lower in the outer circumferential part than in the inner circumferential part of the wafer. Accordingly, simulations are performed for obtaining an appropriate groove depth.

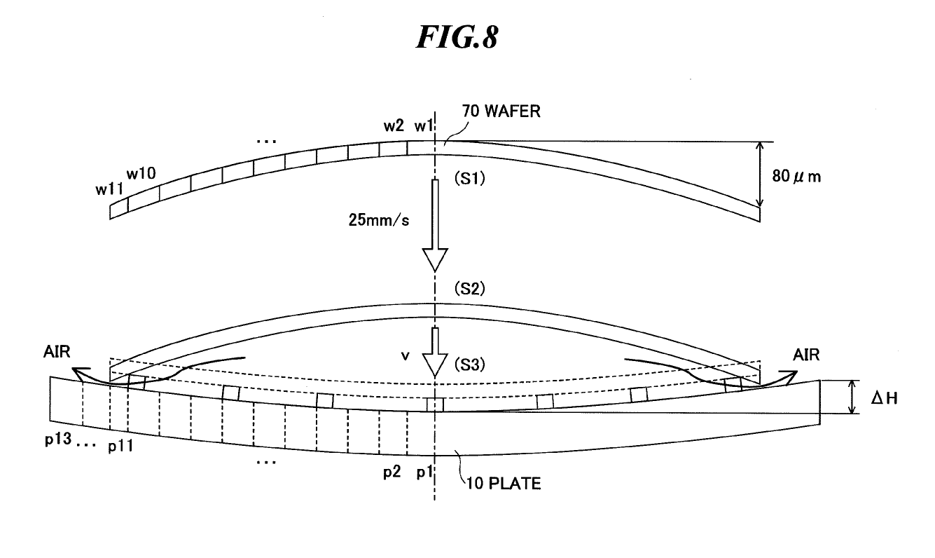

FIG. 8 shows an element model used for simulations. In the simulations, assuming that the plate 10 and the wafer 70 are two-dimensionally axisymmetric, the plate 10 is divided into partial regions p1 to p13, and the wafer 70 is divided into partial regions w1 to w11. The upper surface of the plate 10 has a concave shape (flatness: ΔH) and the wafer 70 has a shape convex upward (flatness: 80 μm). The value of 80 μm as the flatness of the wafer 70 is a large value on the assumption that the condition is bad.

First, the wafer 70 is located above the plate 10 (S1), and the wafer 70 is moved downward at a velocity of 25 mm/s and the outer circumferential part of the wafer 70 is brought into contact with the projections of the plate 10 (S2). Then, the wafer 70 bends at a velocity “v” of the center part, and the gap between the plate 10 and the wafer 70 is uniformized (S3). Concurrently, the air staying between the plate 10 and the wafer 70 is gradually discharged from the outer circumferential part of the wafer 70, and thereby, a time delay is caused until the gap is uniformized. In the simulations, the time delay is expressed by a time constant of 1.3 s.

Further, an equivalent heat transfer coefficient λ_{EQ}(i) between the plate 10 and the wafer 70 is expressed by the following equation.

λ_{EQ}(i)=λ_{AIR}/Gap(i) (i=1, 2, . . . , 11)

Where λ_{AIR} is a heat transfer coefficient of air, and Gap (i) is a gap length between opposed partial regions of the plate 10 and the wafer 70 and temporally varies. The heater provided on the lower surface of the plate 10 provides constant output without feedback control.

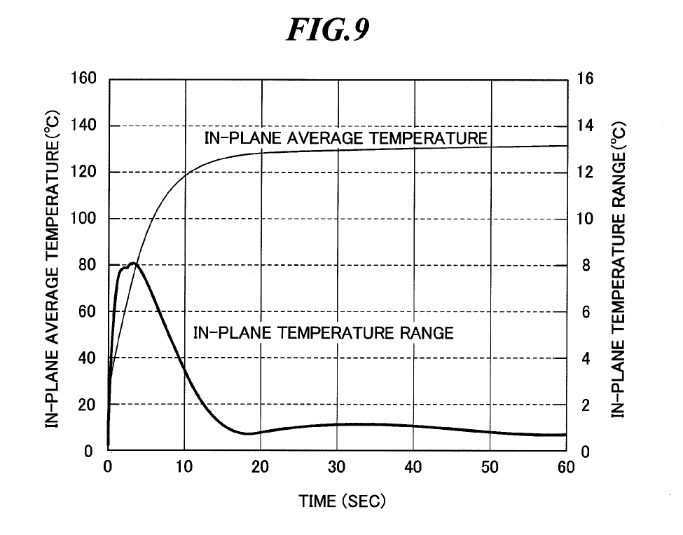

FIG. 9 shows a first simulation result. Here, the flatness ΔH of the plate is set to 40 μm, the diameter of the inner circumference of the groove is set to 292 mm, the diameter of the outer circumference of the groove is set to 306 mm, and the depth of the groove is set to 750 μm. Compared to the experimental result as shown in FIG. 6, although the way that the in-plane temperature range changes is slightly different, the maximum value of the in-plane temperature range is about 8.3° C., and the value near about 7.6° C. as the experimental result is obtained.

On the basis of the simulation, the depth and the size of the groove to be formed on the plate are considered. In the case where there are conditions that the gap length between the plate and the wafer is 100 μm (the value after the gap is uniformized) and that the target temperature is 140° C., targets are follows.

(1) Regarding the time until the average temperature of the wafer reaches 120° C., compared to the time when no groove is formed on the plate, difference therebetween is smaller than 0.5 seconds.
(2) When the position shift of the wafer is ±2 mm, the increase of the maximum value of the in-plane temperature range is smaller than 1° C.
(3) Within the range that satisfies the above-mentioned conditions (1) and (2), compared to a plate having the same shape and the same flatness without groove, the reduction effect of the maximum value of the in-plane temperature range is made to be 2° C. or higher.

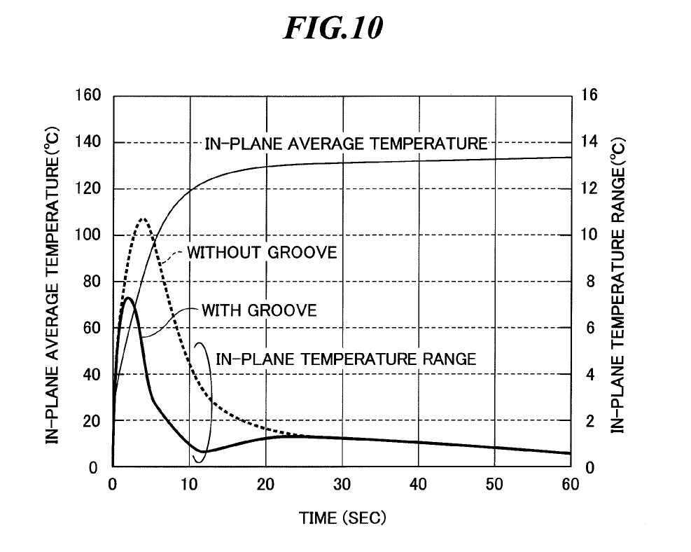

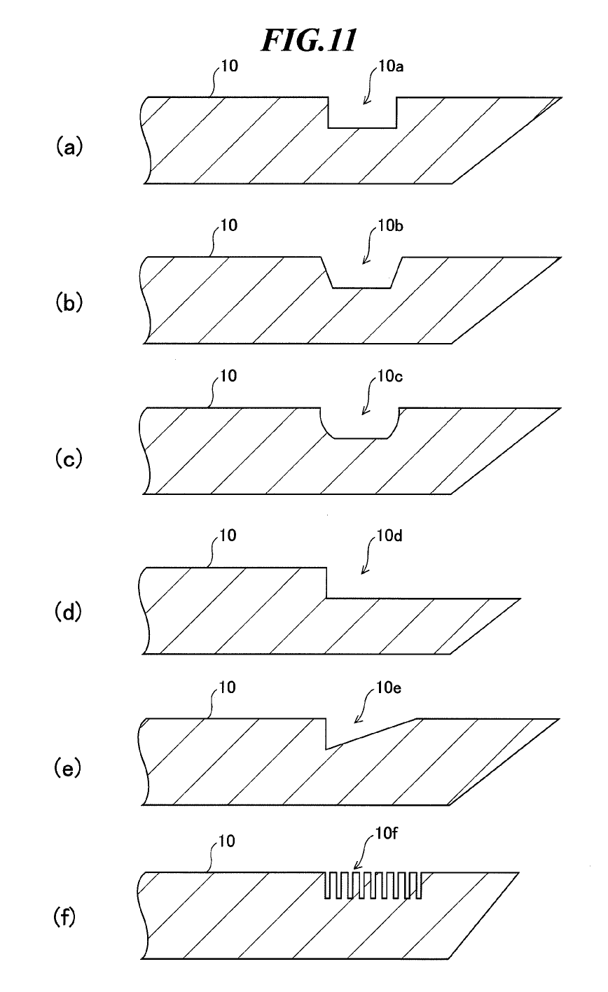

FIG. 10 shows a second simulation result. Here, the flatness ΔH of the plate is set to 40 μm, the diameter of the inner circumference of the groove is set to 292 mm, the diameter of the outer circumference of the groove is set to 306 mm, and the depth of the groove is set to 100 μm. Compared to the case without groove (broken line), the maximum value of the in-plane temperature range becomes lower to about 7.3° C., and the reduction effect of the maximum value of the in-plane temperature range is 3° C. or higher, which exceeds the target. The same simulation is performed for the cases where the depth of the groove is 150 μm and 200 μm, and the groove depth of 200 μm is a boundary that satisfies the condition (2).

Further, a simulation is performed for the case where the diameter of the inner circumference of the groove is set to 240 mm, and the diameter of the outer circumference of the groove is set to 306 mm, and therefore, the width of the groove is set to (306-240)/2=33 mm. In this case, a good result is obtained when the depth of the groove is 20 μm. Generally, when a product obtained by multiplication of the width by the depth of the groove under the substrate (wafer) is in a range from 0.4 to 0.8 (unit: mm²), an effect that uniformizing the temperature distribution of the wafer is seen.

FIG. 11 shows modified examples of groove shapes of the plate in the one embodiment of the present invention. FIG. 11 (a) shows the plate 10 in which the groove 10a having a rectangular sectional shape that has been explained is formed. FIG. 11 (b) shows the plate 10 in which a groove 10b having inclined walls of inner circumference and outer circumference of the groove is formed. In order to suppress the contamination of the wafer due to the groove, it is desirable that the groove is made shallower and tapered. FIG. 11 (c) shows the plate 10 in which a groove 10c having at least a curved part of walls of the groove is formed. In FIG. 11 (b) and FIG. 11 (c), when the diameters of the inner circumference and outer circumference of the groove are defined, their average values are used.

FIG. 11 (d) shows the plate 10 in which a groove (step part) 10d extending to the edge of the plate 10 is formed. FIG. 11 (e) shows a plate 10 in which a groove 10e entirely tapered for reduction of the temperature range variations due to shifts of the wafer is formed. FIG. 11 (f) shows the plate 10 in which plural thin grooves 11f are formed for increasing the heat transfer area to reduce the temperature range in the steady state when the temperature range in the steady state becomes larger due to the groove.

### INDUSTRIAL APPLICABILITY

The present invention can be applied to a substrate temperature control apparatus for controlling a temperature of a substrate such as a semiconductor wafer or a liquid crystal panel at treatment of the substrate.

1. A stage to be used for mounting a substrate having a predetermined diameter in a predetermined position in a substrate temperature control apparatus for controlling a temperature of the substrate, said stage comprising:
a plate formed with a step part, which is lower than a center part, on a first surface facing said substrate in a region including a position corresponding to an edge of said substrate; and
a temperature control unit provided on a second surface opposite to the first surface of said plate.

2. The stage according to claim 1, wherein said step part extends to a distance of 4 mm to 30 mm measured from the position corresponding to the edge of said substrate toward a center of said plate on the first surface of said plate.

3. A stage to be used for mounting a substrate having a predetermined diameter in a predetermined position in a substrate temperature control apparatus for controlling a temperature of the substrate, said stage comprising:
a plate provided with plural projections for supporting a lower surface of said substrate and plural guide members for regulating a position of an edge of said substrate on a first surface facing said substrate, and formed with a step part on the first surface at an outer circumference side than said plural projections and at an inner circumference side than said plural guide members; and
a temperature control unit provided on a second surface opposite to the first surface of said plate.

4. A stage to be used for mounting a substrate having a predetermined diameter in a predetermined position in a substrate temperature control apparatus for controlling a temperature of the substrate, said stage comprising:
a plate provided with plural projections for supporting a lower surface of said substrate and plural guide members for regulating a position of an edge of said substrate on a first surface facing said substrate, and formed with a step part on the first surface at an inner circumference side than said plural guide members, said plural projections being arranged such that at least one projection lies over a region in which said step part is formed; and
a temperature control unit provided on a second surface opposite to the first surface of said plate.

5. The stage according to claim 1, wherein said step part is formed in depth of 20 μm to 200 μm on the first surface of said plate in the region including the position corresponding to the edge of said substrate.

6. The stage according to claim 1, wherein the first surface of said plate has a concave shape at a room temperature.

7. The stage according to claim 1, wherein said temperature control unit includes a planar heater.

8. The stage according to claim 2, wherein said step part is formed in depth of 20 μm to 200 μm on the first surface of said plate in the region including the position corresponding to the edge of said substrate.

9. The stage according to claim 3, wherein said step part is formed in depth of 20 μm to 200 μm on the first surface of said plate in the region including the position corresponding to the edge of said substrate.

10. The stage according to claim 4, wherein said step part is formed in depth of 20 μm to 200 μm on the first surface of said plate in the region including the position corresponding to the edge of said substrate.

11. The stage according to claim 2, wherein the first surface of said plate has a concave shape at a room temperature.

12. The stage according to claim 3, wherein the first surface of said plate has a concave shape at a room temperature.

13. The stage according to claim 4, wherein the first surface of said plate has a concave shape at a room temperature.

14. The stage according to claim 2, wherein said temperature control unit includes a planar heater.

15. The stage according to claim 3, wherein said temperature control unit includes a planar heater.

16. The stage according to claim 4, wherein said temperature control unit includes a planar heater.
